(19) United States
(12) Patent Application Publication
(10) Pub. No.: US 2022/0207889 A1
(43) Pub. Date: Jun. 30, 2022

(54) METHOD FOR RECOGNIZING VEHICLE LICENSE PLATE, ELECTRONIC DEVICE AND COMPUTER READABLE STORAGE MEDIUM

(71) Applicant: STREAMAX TECHNOLOGY CO., LTD., Shenzhen (CN)

(72) Inventors: Xunan LIN, Shenzhen (CN); Kai YE, Shenzhen (CN); Rui WANG, Shenzhen (CN)

(21) Appl. No.: 17/555,835

(22) Filed: Dec. 20, 2021

Related U.S. Application Data
(63) Continuation-in-part of application No. PCT/CN2020/140930, filed on Dec. 29, 2020.

(51) Int. Cl. G06V 20/62; G06T 7/70; G06V 30/148; G06V 30/19; G06V 30/18

(52) U.S. Cl. CPC G06V 20/625; G06T 7/70; G06V 30/18181; G06V 30/19013; G06V 30/148

(57) ABSTRACT

A method for recognizing vehicle license plate is provided, the method includes: performing vehicle license plate detection on a Nth image frame in a video stream to obtain a first vehicle license plate detection result which is used to indicate a position of the first vehicle license plate in the Nth image frame if the first vehicle license plate is included in the Nth image frame; segmenting a character region and a number region from the first vehicle license plate according to the position of the first vehicle license plate in the Nth image frame and content information of the first vehicle license plate if the first vehicle license plate is included in the Nth image frame; and recognizing the character region and the number region segmented from the first vehicle license plate to obtain a first recognition result of the first vehicle license plate.

### CROSS REFERENCE TO RELATED APPLICATION

This application is a continuation-in-part of International patent application No. PCT/CN2020/140930 filed on Dec. 29, 2020, and entitled “method and device for recognizing vehicle license plate, and electronic device”, the disclosure of which is incorporated herein by reference in entirety.

### TECHNICAL FIELD

The present disclosure relates to the technical field of vehicle information recognition, and particularly relates to a vehicle license plate recognition method, a vehicle license plate recognition device, an electronic device and a computer readable storage medium.

### BACKGROUND

In order to facilitate a user to have a trip more quickly, for example, in order to allow a user to enter and get out of a parking lot conveniently and quickly, a vehicle license plate recognition device is usually arranged at an entrance of the parking lot to recognize the vehicle license plates of the vehicles moving in and moving out of the parking lot automatically.

When the existing vehicle license plate recognition methods are used to perform vehicle license plate recognition, sometimes, erroneous recognition results are obtained.

### SUMMARY

A vehicle license plate recognition method is provided in one embodiment of the present disclosure, and a more accurate vehicle license plate recognition result can be obtained.

In order to solve the aforesaid technical problem, the technical solutions used by the embodiments of the present disclosure are introduced as follows:

In aspect one, a vehicle license plate recognition method implemented by an electronic device comprising a memory and at least one processor is provided by one embodiment of the present disclosure, the method including steps of:

by the at least one processor, performing a vehicle license plate detection on a Nth image frame in a video stream to obtain a first vehicle license plate detection result, wherein the first vehicle license plate detection result is used to indicate whether a first vehicle license plate is included in the Nth image frame, and further indicate a position of the first vehicle license plate in the Nth image frame if the first vehicle license plate detection result indicates that the first vehicle license plate is included in the Nth image frame, wherein N is an integer being greater than or equal to 1;

by the at least one processor, segmenting a character region and a number region from the first vehicle license plate according to the position of the first vehicle license plate in the Nth image frame and content information of the first vehicle license plate, if the first vehicle license plate detection result indicates that the first vehicle license plate is included in the Nth image frame; and

by the at least one processor, recognizing the character region and the number region segmented from the first vehicle license plate to obtain a first recognition result of the first vehicle license plate.

In aspect two, an electronic device is provided by one embodiment of the present disclosure, the electronic device includes a memory, at least one processor, and a computer program stored in the memory and executable by the processor, when the computer program is executed by the processor, the at least one processor is configured to:

perform a vehicle license plate detection on a Nth image frame in a video stream to obtain a first vehicle license plate detection result, wherein the first vehicle license plate detection result is used to indicate whether a first vehicle license plate is included in the Nth image frame, and further indicate a position of the first vehicle license plate in the Nth image frame if the first vehicle license plate detection result indicates that the first vehicle license plate is included in the Nth image frame, wherein N is an integer being greater than or equal to 1;

segment a character region and a number region from the first vehicle license plate according to the position of the first vehicle license plate in the Nth image frame and content information of the first vehicle license plate, if the first vehicle license plate detection result indicates that the first vehicle license plate is included in the Nth image frame; and

recognize the character region and the number region segmented from the first vehicle license plate to obtain a first recognition result of the first vehicle license plate.

In aspect three, a computer readable storage medium is provided by one embodiment of the present disclosure, the computer readable storage medium stores a computer program that, when executed by a processor, causes the processor to implement vehicle license plate recognition operations, including:

performing a vehicle license plate detection on a Nth image frame in a video stream to obtain a first vehicle license plate detection result, wherein the first vehicle license plate detection result is used to indicate whether a first vehicle license plate is included in the Nth image frame, and further indicate a position of the first vehicle license plate in the Nth image frame if the first vehicle license plate detection result indicates that the first vehicle license plate is included in the Nth image frame, wherein N is an integer being greater than or equal to 1;

segmenting a character region and a number region from the first vehicle license plate according to the position of the first vehicle license plate in the Nth image frame and content information of the first vehicle license plate, if the first vehicle license plate detection result indicates that the first vehicle license plate is included in the Nth image frame; and

recognizing the character region and the number region segmented from the first vehicle license plate to obtain a first recognition result of the first vehicle license plate.

In aspect four, one embodiment of the present disclosure provides a computer program product that, when executed by an electronic device, causes the electronic device to perform the vehicle license plate recognition method disclosed in the aspect one.

In this embodiment of the present disclosure, since the vehicle license plate is segmented according to the content information of the vehicle license plate, so that more accurate character region and number region of the vehicle license plate can be obtained, and more accurate vehicle license plate recognition result can be obtained after the more accurate character region and number region are recognized.

It should be understood that, regarding the advantageous effects of the second aspect, the third aspect, the fourth aspect and the fifth aspect, reference be made to the relevant descriptions in the first aspect, these advantageous effects will not be repeatedly described herein.

### BRIEF DESCRIPTION OF THE DRAWINGS

In order to describe the embodiments of the present disclosure more clearly, a brief introduction regarding the accompanying drawings that need to be used for describing the embodiments of the present disclosure or the related art is given below.

FIG. 1 illustrates a schematic flow diagram of one vehicle license plate recognition method provided by embodiment one of the present disclosure;

FIG. 2 illustrates a schematic flow diagram of another vehicle license plate recognition method provided by embodiment one of the present disclosure;

FIG. 3 illustrates a schematic diagram of recognizing vehicle license plates in the Middle East, which is provided by embodiment one of the present disclosure; and

FIG. 4 illustrates a schematic structural diagram of an electronic device provided by embodiment three of the present disclosure.

### DESCRIPTION OF THE EMBODIMENTS

In the following description, in order to describe but not intended to limit the present disclosure, concrete details such as specific system structure, technique, and the like are proposed, so that a comprehensive understanding of the embodiments of the present disclosure is facilitated. However, it will be apparent to the ordinarily skilled one in the art that, the present disclosure can also be implemented in some other embodiments without these concrete details. In some other conditions, detailed explanations of method, circuit, device and system well known to the public are omitted, so that unnecessary details can be prevented from obstructing the description of the present disclosure.

It should be understood that, when a term “comprise/include” is used in the description and annexed claims, the term “comprise/include” indicates existence of the described characteristics, integer, steps, operations, elements and/or components, but not exclude existence or adding of one or more other characteristics, integer, steps, operations, elements, components and/or combination thereof.

It should be further understood that, terms “and/or” used in the description and the annexed claims of the present disclosure are referred to as any combination of one or a plurality of listed item(s) associated with each other and all possible items, and including these combinations.

The descriptions of “referring to one embodiment” and “referring to some embodiments”, and the like as described in the specification of the present disclosure means that a specific feature, structure, or characters which are described with reference to this embodiment are included in one embodiment or some embodiments of the present disclosure. Thus, the sentences of “in one embodiment”, “in some embodiments”, “in some other embodiments”, “in other embodiments”, and the like in this specification are not necessarily referring to the same embodiment, but instead indicate “one or more embodiments instead of all embodiments”, unless there is a special emphasis in other manner otherwise.

### Embodiment One

Erroneous recognition results can be obtained during the use of existing vehicle license plate recognition methods. According to analysis, inventors of the present disclosure may be aware of the fact that, the existing vehicle license plate recognition methods can only recognize the vehicle license plates in a fixed format, so that character information in the vehicle license plate needs to be divided into a single regular character region, and each character needs to be recognized in a fixed window, which means that, once the format of the vehicle license plate is changed, serious recognition errors would be resulted, for example, a plurality of characters including Arabic numerals and Arabic languages are provided on a Middle East vehicle license plate. The characters of the vehicle license plate are also arranged in a wide variety of patterns, information are redundant, but the sizes of the characters are small. When one existing vehicle license plate recognition method is adopted, serious segmentation errors and recognition errors can be caused, the reduction of the recognition accuracy of a single segmented region further results in a great reduction of the recognition accuracy of the overall vehicle license plate, so that a low accuracy of the obtained vehicle license plate recognition result is caused. In order to solve the above-mentioned technical problem, one embodiment of the present disclosure provides a new vehicle license plate recognition method. In the vehicle license plate recognition method, the vehicle license plate is segmented according to the content information of the vehicle license plate and the character region and the number region of the vehicle license plate is obtained, then, the character region and the number region are recognized to obtain the final vehicle license plate recognition result. Since the vehicle license plate is segmented according to the content information of the vehicle license plate, more accurate character region and number region of the vehicle license plate can be obtained, then, more accurate vehicle license plate recognition results can be obtained after the more accurate character region and the number region are further recognized.

A vehicle license plate recognition method according to this embodiment of the present disclosure is described below with reference to the accompanying drawings.

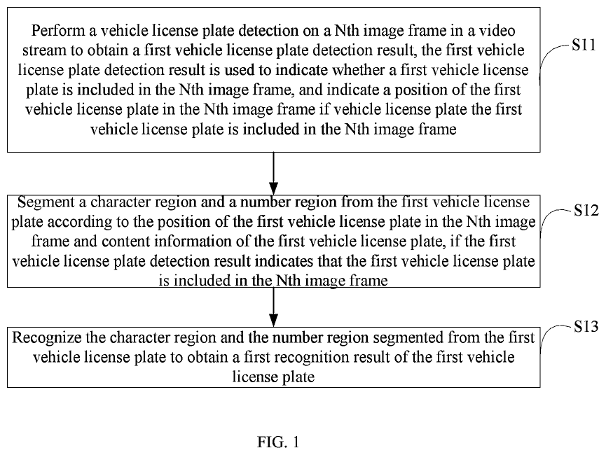

FIG. 1 illustrates a flow diagram of a vehicle license plate recognition method according to embodiment one of the present disclosure. This vehicle license plate recognition method is implemented by an electronic device including a memory and at least one processor. In this embodiment of the present disclosure, the wordings “first” and “second” in the first vehicle license plate and the second vehicle license plate are only used to distinguish vehicle license plates from different image frames, and the wordings “first” and “second” do not have special meanings, other term which has the wording “first” and “second” is similar to the wordings of “first” and “second” in the first vehicle license plate and the second vehicle license plate, it is not repeatedly explained hereinafter.

The vehicle license plate recognition method includes the following steps:

In a step S11, a vehicle license plate detection is performed on a Nth image frame in a video stream to obtain a first vehicle license plate detection result, wherein the first vehicle license plate detection result is used to indicate whether the Nth image frame includes a first vehicle license plate, and further indicates the position of the first vehicle license plate in the Nth image frame if the first vehicle license plate detection result indicates that the first vehicle license plate is included in the Nth image frame, wherein N is an integer and N is greater than or equal to 1.

In this embodiment of the present disclosure, the video stream includes a plurality of image frames, the Nth image frame in the step S11 can be any image frame in the video stream, for example, when N is equal to 1, the Nth image frame represents a first image frame in the video stream, when N is equal to 2, the Nth image frame represents a second image frame in the video stream. In this embodiment, the maximum value of N is equal to the number of image frames included in the video stream, for example, the maximum value of N is 30 if the number of image frames included in the video stream is 30.

In some embodiments, step S11 further includes a step of performing vehicle license plate detection on the Nth image frame in the video stream through the first target detection model to obtain the first vehicle license plate detection result.

In this embodiment, after the first target detection model is used to perform vehicle license plate detection, the position of the first vehicle license plate in the Nth image frame and the corresponding confidence are obtained. When the confidence is greater (e.g., greater than a preset confidence threshold), it indicates that the first vehicle license plate detection result for the first vehicle license plate, which is output by the first target detection model, has a higher confidence, and the position of the first vehicle license plate in the Nth image frame is provided for calculation. Wherein, the position of the first vehicle license plate in the Nth image frame can be represented by a rectangular detection frame located by the coordinates of an upper left point (x1, y1) and a lower right point (x2, y2) of the vehicle license plate, as an alternative, the position of the first vehicle license plate in the Nth image frame can be presented by a polygon frame represented by four angular point coordinates. Where the first target detection model can include but is not limited to a target detection model formed by a target detection algorithm such as YOLO, SSD, and the like. The first target detection model is a model obtained by training the second target detection model, and this model is provided with a neural network. In one preferable embodiment, the second target detection model is trained in the manner described below:

The image captured by a camera is obtained, a coordinate of a vehicle license plate in the image are manually labeled, the corresponding training label is obtained, and the second target detection model is trained by using the image captured by the camera having the training label, so that the first target detection model is obtained. It should be noted that, when the countries corresponding to the vehicle license plates which are included in the images captured by the camera are different, the countries corresponding to the vehicle license plates recognized by the obtained first target detection model are different, too. For example, when the country corresponding to the vehicle license plate is China, the country corresponding to the vehicle license plate that can be recognized by the obtained first target detection model is China, too. When the region corresponding to the vehicle license plate is the North American region, the region corresponding to the vehicle license plate that can be recognized by the obtained first target detection model is the North America region, too. When there are many countries corresponding to the vehicle license plates, there are also many countries corresponding to the vehicle license plates that can be recognized by the obtained first target detection model, that is, vehicle license plates of different countries are used to train the second target detection model, such that the obtained first target detection model can recognize the vehicle license plates in different countries.

In a step of S12, the character region and the number region are segmented from the first vehicle license plate according to the position of the first vehicle license plate in the Nth image frame and the content information of the first vehicle license plate, if the first vehicle license plate detection result indicates that the Nth image frame includes the first vehicle license plate.

In this embodiment of the present disclosure, the content information of the first vehicle license plate refers to the character region and the number information contained in the first vehicle license plate, and the positions of the character region and the number information in the region of the first vehicle license plate.

In addition to the number information, character information is also included in the vehicle license plate, since the recognition of the number information and the recognition of the character region are different, as a result, in the embodiment of the present disclosure, the character region and the number region need to be respectively segmented from the first vehicle license plate, so that an accurate recognition result can be obtained by subsequent recognition of the characters in the character region and the numbers in the number region.

Of course, if the first vehicle license plate detection result indicates that the Nth image frame does not include the first vehicle license plate, the vehicle license plate detection is continued to be performed on the next image frame in the Nth image frame.

In a step of S13, the character region and the number region segmented from the first vehicle license plate are recognized to obtain the first recognition result of the first vehicle license plate.

In this embodiment, the segmented character region and the number region are respectively recognized, so that the first recognition result of the first vehicle license plate is obtained, where the first recognition result includes city information and vehicle license plate number information of the first vehicle license plate, and the like.

In this embodiment of the present disclosure, since the vehicle license plate is segmented according to the content information of the vehicle license plate, more accurate character region and number region of the vehicle license plate can be obtained, and more accurate vehicle license plate recognition result can be obtained after the more accurate character region and number region are recognized.

In some embodiments, the step S13 includes: recognizing the character region and the number region segmented from the first vehicle license plate through a first vehicle license plate recognition model so as to obtain a first recognition result of the first vehicle license plate. Where the first vehicle license plate recognition model is a model obtained by training the second vehicle license plate recognition model, and the first vehicle license plate recognition model is a model provided with a neural network. As an example, the second vehicle license plate recognition model is trained in the manner described below:

the segmented vehicle license plate image which is input to the second vehicle license plate recognition model is obtained, and the corresponding training label is obtained by manually labeling or synthesizing strings in the content of vehicle license plate. The strings in the content of vehicle license plate include characters and numbers. The second vehicle license plate recognition model is trained by using the segmented vehicle license plate images and the training labels, so that the first vehicle license plate recognition model is obtained.

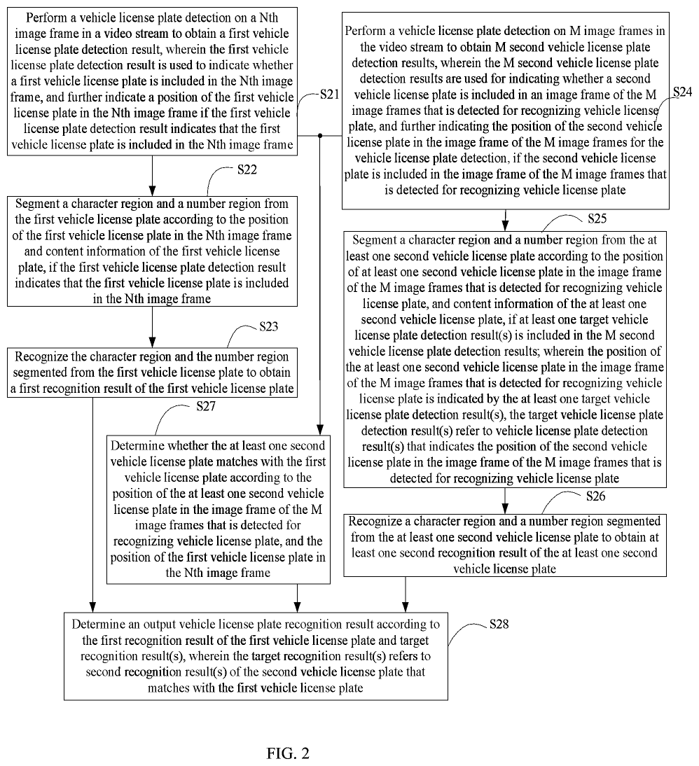

FIG. 2 illustrates a flow diagram of another vehicle license plate recognition method according to one embodiment of the present disclosure. In this embodiment, in order to improve the accuracy of the output vehicle license plate recognition result, in addition to performing vehicle license plate detection on the current image frame (i.e., the Nth image frame), vehicle license plate detection is further performed on the next image frame (i.e., the (N+1)th image frame), finally, the detection results of the adjacent image frames are combined to obtain a final output vehicle license plate recognition result.

In a step of S21, a vehicle license plate detection is performed on the Nth image frame in the video stream to obtain the first vehicle license plate detection result, where the first vehicle license plate detection result is used to indicate whether the Nth image frame includes a first vehicle license plate, and further indicate the position of the first vehicle license plate in the Nth image frame if the first vehicle license plate detection result indicates that the first vehicle license plate is included in the Nth image frame, wherein N is an integer and N is greater than or equal to 1.

In a step of S22, the character region and the number region are segmented from the first vehicle license plate according to the position of the first vehicle license plate in the Nth image frame and the content information of the first vehicle license plate, if the first vehicle license plate detection result indicates that the first vehicle license plate is included in the Nth image frame.

In a step of S23, the character region and the number region segmented from the first vehicle license plate are recognized to obtain the first recognition result of the first vehicle license plate.

In a step of S24, a vehicle license plate detection is performed on M image frames in the video stream respectively to obtain M second vehicle license plate detection results, where the second vehicle license plate detection result is used to indicate whether a second vehicle license plate is included in one image frame of the M image frames for the vehicle license plate detection; the position of the second vehicle license plate in the image frame of the M image frames for the vehicle license plate detection is further indicated if the second vehicle license plate detection result indicates that the second vehicle license plate is included in the image frame of the M image frames for the vehicle license plate detection, the M image frames are the image frames subsequent to the Nth image frame, and M is greater than or equal to 1.

In this embodiment of the present disclosure, when M is equal to 2, vehicle license plate detection is performed on the two image frames (e.g., the (N+1)th image frame and the (N+2)th image frame) respectively, the process of performing vehicle license plate detection and vehicle license plate recognition on each of the (N+1)th image frame and the (N+2)the image frame is similar to the process of performing vehicle license plate detection and vehicle license plate recognition on the Nth image frame, this process is not be repeatedly described herein.

In a step of S25, the character region and the number region are segmented respectively from the at least one second vehicle license plate according to the position of the at least one second vehicle license plate in the image frame of the M image frames for the vehicle license plate detection, and the content information of the at least one second vehicle license plate, if at least one target vehicle license plate detection result is included in the M second vehicle license plate detection results; where the position of the at least one second vehicle license plate in the image frame of the M image frames is indicated by the at least one target vehicle license plate detection result, the target vehicle license plate detection result refers to the vehicle license plate detection result indicating the position of the second vehicle license plate in the image frame of the M image frames for the vehicle license plate detection.

Assuming that the second vehicle license plate detection result obtained after vehicle license plate detection is performed on the (N+1)th image frame is M1, the M1 indicates that the second vehicle license plate ml is included in the (N+1) image frame. The second vehicle license plate detection result obtained after vehicle license plate detection is performed on the (N+2) image frame is M2, the M2 indicates that the(N+1)th image frame does not include the second vehicle license plate, M1 is the target vehicle license plate detection result. The character region and the number region are segmented from M1 according to the position of m1 in the (n+1)th image frame and the content information of m1.

In a step of S26, the character region and the number region segmented from the at least one second vehicle license plate are recognized to obtain at least one second recognition result of the at least one second vehicle license plate.

In this embodiment of the present disclosure, assuming that the character region and the number region of the two second vehicle license plates (i.e., the second vehicle license plate m1 and the second vehicle license plate m2) need to be recognized, the character region and the number region of the second vehicle license plate m1 are recognized to obtain the second recognition result, then, the character region and the number region of the second vehicle license plate m2 are recognized to obtain another second recognition result.

In a step of S27, whether the at least one second vehicle license plate matches with the first vehicle license plate is determined according to the position of the at least one second vehicle license plate in the image frame of the M image frames for the vehicle license plate detection and the position of the first vehicle license plate in the Nth image frame.

In this embodiment, if the first vehicle license plate matches with the second vehicle license plate, it means that the first vehicle license plate and the second vehicle license plate are the same vehicle license plate, if the first vehicle license plate does not match with the second vehicle license plate, it means that the first vehicle license plate and the second vehicle license plate are not identical. In particular, the position of the first vehicle license plate and the position of the second vehicle license plate can be compared, if the change of positions of the first vehicle license plate and the second vehicle license plate in two adjacent image frames is small, it is determined that the first vehicle license plate matches with the second vehicle license plate, otherwise, it is determined that the first vehicle license plate does not match with the second vehicle license plate.

It should be noted that step S27 can also be performed subsequent to the step S24 or subsequent to the step S25, the execution sequence of the step S27 is not limited herein.

In a step of S28, the output vehicle license plate recognition result is determined according to the first recognition result of the first vehicle license plate and the target recognition result, where the target recognition result refers to the second recognition result corresponding to the second vehicle license plate matched with the first vehicle license plate.

In this embodiment, the output vehicle license plate recognition result can be determined according to the confidence of the position of the first vehicle license plate in the first recognition result and the confidence of the position of the second vehicle license plate in the target recognition result. Alternatively, the information in the first recognition result and the information in the target recognition result can be combined, for example, some information in the first recognition result and some information in the target recognition result are selected, and the selected two parts of information are combined to determine the output vehicle license plate recognition result.

In this embodiment of the present disclosure, whether adjacent image frames include the same vehicle license plate is determined, when the adjacent image frame include the same vehicle license plate, the output vehicle license plate recognition result is determined according to the recognition results of the same vehicle license plate in the adjacent image frames respectively. That is, the final vehicle license plate recognition result is determined by adding the recognition results of the same vehicle license plate in other image frames, so that the accuracy of the obtained vehicle license plate recognition result can be improved.

In some embodiments, if some contents are respectively selected from the first recognition result and the target recognition result and are combined into the final vehicle license plate recognition result, and the number of the target recognition results is greater than or equal to 2, the step S28 includes:

step A1: the first recognition result is split according to a preset output format to obtain a first split content, where the first split content includes at least two split sub-contents, each of the split sub-contents corresponds to one confidence.

Step A2: the at least two target recognition results are split to obtain at least two second split contents according to the preset output format, where the second split contents include at least two split sub-contents, and each of the split sub-contents corresponds to one confidence.

Step A3: the values of the confidences are accumulated corresponding to a same split sub-content in the first split content and the at least two second split contents, and the split sub-contents that have higher accumulated values of confidences are selected to make up the output vehicle license plate recognition result according to the preset output format.

In this embodiment, the first recognition result and the target recognition result are split according to the preset output format, so that various kinds of vehicle license plates are included in the same structural frame, then, the accumulated value of the confidence corresponding to the same split sub-content is determined according to the split sub-contents and the confidences corresponding to the split sub-contents, at the same position of the preset output format, the higher the accumulated value of confidence corresponding to the split sub-contents which corresponds to the position, the higher the probability of the split sub-contents corresponds to the confidence with high accumulated value, and the higher the accuracy of the output vehicle recognition result constituted of the split sub-contents with high accumulated confidence selected according to the preset output format, that is, the vehicle license plate recognition result is output according to a voting mechanism. For example, assuming that the preset output format is “city”+“vehicle license plate number”, the split sub-contents corresponding to the first recognition result are “DUBAI”+“I5555” respectively, the corresponding confidences are “0.6” and “0.7” respectively, the split sub-contents corresponding to target recognition result 1 are “DUBAI”+“I 5556”, and the corresponding confidences are “0.7” and “0.6”, the split sub-contents corresponding to target recognition result 2 is “DUBAL”+“I 5555”, and the corresponding confidences are “0.5” and “0.5”, thus, the accumulated confidence corresponding to the split sub-content “DUBAI” is “1.3”, the accumulated confidence corresponding to the split sub-content “DUBAL” is “0.5”. The accumulated confidence corresponding to the split sub-content “I 55555” is “1.2”, the confidence corresponding to the split sub-content “I 55556” is “0.6”, since 1.3 is greater than 0.5, 1.2 is greater than 0.6, so that the obtained vehicle license plate recognition result is “DUBAI 55555”.

In some embodiments, if the number of the first vehicle license plates and the number of the second vehicle license plates are greater than 1, the step S27 includes:

in a step of B1, M image frame queues are selected from the image frames ranging from the Nth image frame to the (N+M) image frame, where each image frame queue includes two adjacent image frames.

In this embodiment of the present disclosure, after vehicle license plate detection is performed on the Nth image frame, vehicle license plate detection is further perform on M the image frames subsequent to the Nth image frame, that is, vehicle license plate detection is performed on the image framed ranging from the Nth image frame to the (N+M)th image frame. Two adjacent image frames in the (M+1) image frames are grouped into one single image frame queue, so that M image frame queues are obtained.

In a step of B2, whether the first vehicle license plates match with the second vehicle license plates is determined according to the positions of the second vehicle license plates in the image frame queues and the positions of the first vehicle license plates in the image frame, with regard to all image frames in the M image frame queues.

The step B2 is repeatedly performed until determination of matching of the first vehicle license plates and the second vehicle license plates in all image frames of the M image frame queues is completed.

For example, assuming that M=2, N=1, the first image frame and the second image frame in the video stream are grouped into one image frame queue (this image frame queue is assumed to be image frame queue 1), the second image frame and the third image frame is grouped into an image frame queue (this image frame queue is assumed to be image frame queue 2), whether the first vehicle license plate matches with the second vehicle license plate according to the position of the second vehicle license plate in the second image frame and the position of the first vehicle license plate in the first image frame. Then, whether the first vehicle license plate matches with the second vehicle license plate is determined according to the position of the second vehicle license plate in the third image frame and the position of the first vehicle license plate in the second image frame. It should be noted that, the aforesaid second vehicle license plate refers to a vehicle license plate in an image frame subsequent to the video stream in the image frame queue, such as in the image frame queue 1, the second image frame is the image frame subsequent to the video stream; however, the second image frame becomes the image frame preceding the video stream in the image frame queue 2.

In this embodiment of the present disclosure, when considering that the image frame where the first vehicle license plate is positioned and the image frame where the second vehicle license plate is positioned are adjacent image frames, the probability that the first vehicle license plate and the second vehicle license plate are the same vehicle license plate is relatively higher, thus, two matched vehicle license plates can be searched out faster by performing matching on the first vehicle license plate and the second vehicle license plate in two adjacent image frames.

In some embodiments, the step B2 of determining whether the first vehicle license plate matches with the second vehicle license plate according to the position of the second vehicle license plate in the image frames of the image frame queue and the position of the first vehicle license plate in each image frame of the image frame queue includes:

in a step of B21, an IoU (Intersection over Union) of a detection frame Rᵢ and a detection frame Rⱼ are determined to obtain IoU of elements in sequences S₁ and S₂. Where the detection frame Rᵢ is any of the elements in the sequence S₁, the detection frame Rⱼ is any of the elements in the sequence S₂. The sequence S₁ includes detection frames of the first vehicle license plate. The sequence S₂ includes detection frames of the second vehicle license plate. The position of the first vehicle license plate in the Nth image frame and the position of the second vehicle license plate in the (N+1)th image frame are represented by the corresponding detection frames.

In this embodiment of the present disclosure, two sets which are comprised of detection frames of two adjacent image frames are initialized, where one set is used for storing detection frames of the first vehicle license plate, and the other set is used for storing detection frames of the second vehicle license plate. The two sets are arranged as a left sequence S₁ and a right sequence S₂ of bipartite graph through spatial position relationship. For example, all detection frames of the Nth image frame are ordered according to a spatial position rule (e.g., Euclidean distance from a center of coordinates of the detection frame to an origin of coordinates of the detection frame) to make up the left sequence, in a similar way, all detection frames of the (N+1)the image frame are ordered to make up the right sequence.

The detection frame Rᵢ and the detection frame Rⱼ are repeatedly extracted from the two sequences S₁ and S₂, and the IoU of the detection frames Rᵢ and Rⱼ, the IoU is the ratio of the intersection of the two detection frames Rᵢ and Rⱼ to the union of the two detection frames Rᵢ and Rⱼ, where:

$${IoU}_{ij} = \frac{\vert {R}_{i} ⋂ {R}_{j} \vert}{\vert {R}_{i} ⋃ {R}_{j} \vert}$$

In a step of B22, the IoU is taken as a weight value of an edge that connects the detection frame R₁ with the detection frame R₂.

In a step of B23, the detection frames in the sequence S₁ and the sequence S₂ are taken as a vertex of the bipartite graph, and the weight value of the vertex of the bipartite graph is initialized; where the weight value of each vertex in the sequence S₁ is a maximum weight value of the edge connected with the detection frame that corresponds to the vertex in the sequence S1, and the weight value of each vertex in the sequence S₂ is a first preset value.

The first preset value can be a numeral value less than 0.5, for example, the first preset value is 0.

In a step of B24, with regard to the vertex X in the sequence S₁, an edge which has the weight value being identical to the weight value of the vertex X in the sequence S₂ is searched, it is determined that the first vehicle license plate corresponding to the vertex X in the sequence S₁ is successfully matched if the edge which has the weight value being identical to the weight value of the vertex X is searched in the sequence S₂; or it is determined that the first vehicle license plate corresponding to the vertex X in the sequence S₁ is not matched if the edge that has the weight value being identical to the weight value of the vertex X cannot be searched in the sequence S₂, where the vertex X is any vertex in the sequence S₁.

In this embodiment of the present disclosure, the determination of edges corresponding to various vertexes in the sequence S₁ is performed. Since IoU is taken as the weight value of the edge connecting the detection frame Rᵢ with the detection frame Rⱼ, thus, the greater the weight value of the edge of the detection frames Rᵢ and Rⱼ, the greater the overlapped region of the detection frames Rᵢ and Rⱼ, moreover, due to the fact that the weight value of each vertex in the sequence S₁is a maximum weight value of the edge that connects the detection frame corresponding to the vertex, thus, whether the first vehicle license plate corresponding to the detection frame matches with the second vehicle license plate is determined by judging whether there is an edge that has the weight value being identical to the weight value of the vertex X in the sequence S₂, wherein the detection frame corresponds to the vertex X, so that the accuracy of vehicle license plate matching result can be improved.

In some embodiments, when matching is performed on a plurality of first vehicle license plates and a plurality of second vehicle license plates respectively, data association can be performed on multiple targets (i.e., the first vehicle license plates and the second vehicle license plates) in each image frame by means of a Hungary algorithm or a KM algorithm, thereby achieving optimal matching. Furthermore, unique IDs (Identity Documents) of vehicle license plates corresponding to the detection frames of the image frames are established for the detection frames of the different image frames obtained by matching. In this way, continuously tracking each vehicle license plate in one picture is facilitated, especially when multiple vehicle license plates are detected in the picture, matching relationships between the vehicle license plates in the preceding and subsequent image frames can be ensured. For example, when the first recognition result and the second recognition result are split according to the preset output format, the first recognition result and the second recognition result which correspond to the same ID can be split according to the preset output format.

In some embodiments, the first vehicle license plates corresponding to the vertexes in the sequence S₁ can be matched according to the order of the detection frames in the sequence S₁ (e.g., from front to back, or from back to front).

In some embodiments, in the step B24, determining that the first vehicle license plate corresponding to the vertex X in the sequence S₁ is not matched if an edge which has the weight value being identical to the weight value of the vertex X cannot be searched in the sequence S₂ includes:

in a step of B241, the weight value of the vertex X is subtracted by a second preset value if the edge which has the weight value being identical to the weight value of the vertex X cannot be searched, and the weight value of the vertex which corresponds to the detection frame is increased by the second preset value, where this detection frame is connected with a detection frame that corresponds to the vertex X.

Where the second preset value is greater than 0, since the second preset value is greater than 0, thus, after the second preset value is subtracted from the weight value of the vertex X, the remaining weight value of the vertex X would be less than its original weight.

In a step of B242, the next vertex of the vertex X is taken as a new vertex X, and the step (i.e., the step B24) of searching an edge which has the weight value being identical to the weight value of the vertex X in the sequence S₂ and the subsequent steps with regarding to the vertex X in the sequence S₁ are performed again, and it is determined that the first vehicle license plate corresponding to the vertex X in the sequence S₁ is not matched when the weight value of the vertex X becomes 0.

In particular, the matching principle is that: determination of matching is only performed on the edge which has the weight value identical to the weight value (i.e., the assigned value of the left vertex by initialization) of the left vertex, if a matched edge cannot be searched, the value of the left vertex corresponding to this path is reduced by D, and the value of the right vertex is increased by d, and searching out an edge that matches with the next vertex of the left sequence is continued to be performed.

In this embodiment of the present disclosure, after the edge that matches with the vertex corresponding to the detection frame of the first vehicle license plate cannot be searched out, the weight value of the vertex corresponding to the detection frame of the first vehicle license plate is reduced, and searching an edge that matches with the vertex with reduced weight value is continuously performed and this step is not stopped until the weight of the vertex with reduced weight value (when the vertex X is not matched, it means that the detection frame of the first vehicle license plate corresponding to the vertex X originally appearing in the image frame is no longer existed in the subsequent image frame, which indicates that the first vehicle license plate corresponding to the vertex X is removed from the field of view) is zero. That is, the probability of searching out the matched edge can be improved by gradually reducing the weight values of the vertex X.

In some embodiments, the step S13 (or the step S23) includes:

combining the character region and the number region segmented from the first vehicle license plate into first information to be recognized in a fixed format, and recognizing the first information to be recognized to obtain the first recognition result of the first vehicle license plate.

In this embodiment of the present disclosure, considering that the recognition difficulty will be increased due to recognition of information in different formats, thus, in order to reduce the difficulty in recognition and improve accuracy in recognition, the character region and the number region in the vehicle license plate are combined into the information to be recognized in the fixed format. For example, the vehicle license plates in the Middle East are taken as an example, there are various types of vehicle license plates in Middle East, and the arrangements and the layout of the vehicle license plates in Middle East are all different, there are single-row vehicle license plates, and there are double-row and multi-row vehicle license plates. What's more, the distributions of character regions in the vehicle license plates are also different, which increases difficulties in vehicle license plate recognition. In order to improve the accuracy of recognition, the segmented parts of the vehicle license plate are spliced according to the fixed format, for example, the segmented parts of the vehicle license plate are spliced according to the fixed format of left character and right number, so that different vehicle license plates are ensured to be in the single-row structure before they are input to the first vehicle license plate recognition model. In this way, the types of the input data can be further unified and the problem can be simplified, thus, the first vehicle license plate recognition model has a higher accuracy in recognition, and has a better applicability on recognition of vehicle license plates in different countries.

It should be noted that, the aforesaid steps are also performed on the character region and the number region segmented in the second vehicle license plate, and these steps will not be repeatedly described herein.

In some embodiments, in the step S12 (or the step S22), segmenting the character region and the number region from the first vehicle license plate according to the position of the first vehicle license plate in the Nth image frame and the content information of the first vehicle license plate, includes:

In a step of C1, the format of the first vehicle license plate is determined according to the content information of the first vehicle license plate, where the format of the first vehicle license plate is used to indicate the positions of the character region and the number region in the first vehicle license plate respectively.

In this embodiment of the present disclosure, the correspondence relationship between the content information of different vehicle license plates and the formats of the vehicle license plates is pre-stored, after the content information of the vehicle license plate is obtained, the format of the vehicle license plate corresponding to the content information of the vehicle license plate is determined according to the stored correspondence relationship.

In a step of C2, the character region and the number region are segmented from the first vehicle license plate according to the position of the first vehicle license plate in the Nth image frame and the format of the first vehicle license plate.

In this embodiment of the present disclosure, since the correspondence relationship between the content information of the different vehicle license plates and the formats of the corresponding vehicle license plates is pre-stored, the format of the vehicle license plate is used to indicate the position of the character region and the position of the number region in the vehicle license plate respectively, therefore, the character region and the number region of the vehicle license plate can be quickly extracted according to the format of the vehicle license plate.

In some embodiments, in the step S12 (or the step S22), segmenting the character region and the number region from the first vehicle license plate according to the position of the first vehicle license plate in the Nth image frame and the content information of the first vehicle license plate, includes:

in a step of D1, the region of the first vehicle license plate is extracted from the Nth image frame in the Nth image frame according to the position of the first vehicle license plate so as to obtain the first vehicle license plate image.

In this embodiment of the present disclosure, since the first vehicle license plate image is the image corresponding to the region of the first vehicle license plate extracted from the Nth image frame, thus, the number of pixels of the first vehicle license plate image is less than the number of pixels of the Nth image frame, that is, the number of pixels to be processed subsequently is reduced, so that the resources of the electronic device are conserved.

In a step of D2, the at least one processing performed on the first vehicle license plate image includes: correction processing, image enhancement processing, noise cancellation processing, defuzzification processing, and normalization processing, where the correction processing is used for correcting a first vehicle license plate image having angular deflection as a first flatten vehicle license plate image, the normalization processing is used for realizing standardized distribution of a pixel value range of the first vehicle license plate through normalization processing.

The corrected image can increase the effective pixel area.

Where the image enhancement process refers to adding some additional information into the original image or performing data transformation on the original image using some technical means, such that some features of interest in the original image are selectively highlighted or some unwanted features in the original image are suppressed (hidden), and the processed image can match with visual response characteristic. The image enhancement processing can be implemented by using the existing image enhancement algorithm in this embodiment.

Where the defuzzification process can reduce ghost due to motion blur, and thus make the vehicle license plate be clearer.

Where the normalization processing can enable the value range of pixels of the vehicle license plate be in standardized distribution to meet the processing requirements of neural network.

In a step of D3, the character region and the number region are segmented from the first processed vehicle license plate image.

Due to the fact that, it is easier to recognize the vehicle license plate in the first processed vehicle license plate image, thus, the corresponding character region and the number region can be segmented from the first processed vehicle license plate image more accurately.

In some embodiments, the step D3 includes:

segmenting the character region and the number region of the pixel level from the first processed vehicle license plate image through a semantic segmentation model.

Where the semantic segmentation model is used to: segment different regions from the first processed vehicle license plate image, recognize the positions which correspond to province information, recognize the characters, recognize the position which corresponds to the vehicle license plate number information, and recognize the numbers, etc.

In this embodiment of the present disclosure, the semantic segmentation model is a neural network model that needs to be trained by ten millions of data before being applied. In particular, the trained data is the position of the vehicle license plate in the image frame, which is detected by the first target detection model, the trained label are different regions after the vehicle license plate is segmented manually, these different regions include character regions and number regions. The trained semantic segmentation model can segment the character region of pixel level and the number region of pixel level from the vehicle license plate image. Since the semantic segmentation model is used to perform pixel-level classification, prediction, label inference on city information (e.g., Arabic city information) to achieve fine-grained inference, each pixel is labeled as the category of the closed region thereof, then, the learned recognition feature semantics are projected onto one pixel space (high resolution) to obtain one dense classification, and the final result of city information is output.

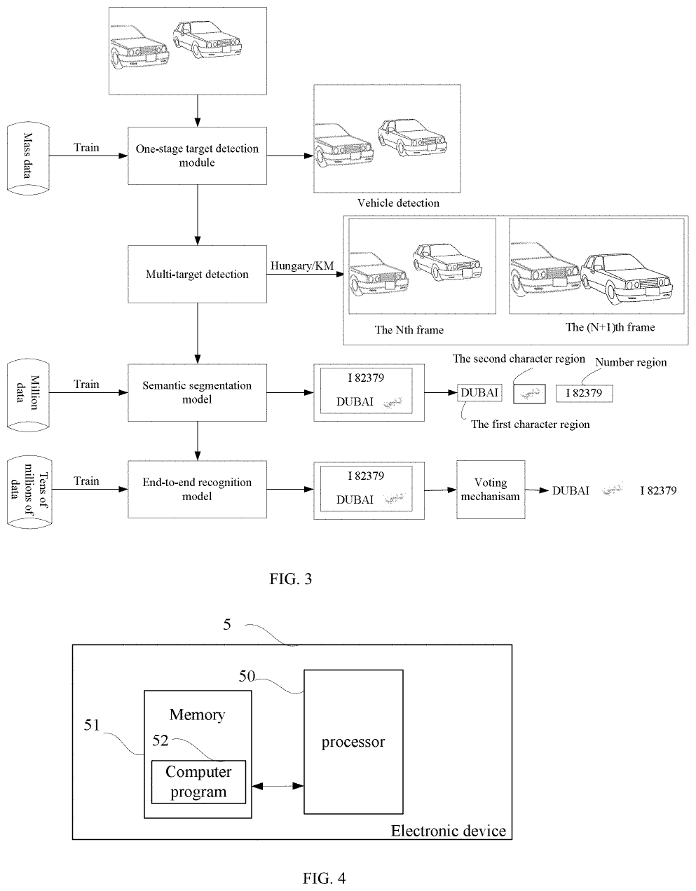

FIG. 3 illustrates a schematic diagram of recognizing vehicle license plate using the vehicle license plate recognition method according to one embodiment of the present disclosure.

In the FIG. 3, one-stage target detection model is used in the first target detection model, matching is performed on the first vehicle license plate and the second vehicle license plate in an image frame queue using a multi-target detection algorithm such as a Hungary algorithm or a KM algorithm. After the first vehicle license plate and the second vehicle license plate that match with each other are determined according to the multi-target detection algorithm, the character region and the number region are segmented from the first vehicle license plate through the semantic segmentation model, two character regions (i.e., city information) and one number region are segmented from the second vehicle license plate, wherein the two character regions are the first character region and the second character region, the information of the first character region is an English word “DUBAI”, and the second character region is the word corresponding to the Arabic spelling of DUBAI. The first character region, the second character region and the number region are spliced according to the format of the left word right number, then, the spliced information is recognized through an end-to-end recognition model (i.e., the aforesaid first vehicle license plate recognition model) to obtain the vehicle license plate recognition result, and then output the obtained vehicle license plate recognition result.

It should be understood that, the values of serial numbers of the steps in the embodiments described above do not mean a sequencing of execution sequences of the steps, the execution sequences of the steps should be determined by functionalities and internal logic of the steps, and shouldn't be regarded as limitation to an implementation process of the embodiment of the present disclosure.

### Embodiment Two

FIG. 4 illustrates a schematic structural diagram of an electronic device 5 according to one embodiment of the present disclosure. The electronic device can be a server or a terminal device, as shown in FIG. 5, the electronic device 5 in this embodiment includes at least one processor 50 (only one processor is shown in FIG. 5), a memory 51, and a computer program 52 stored in the memory 51 and executable on the at least one processor 50, where when the computer program 52 is executed by the at least one processor 50, the at least one processor 50 is configured to:

perform a vehicle license plate detection on a Nth image frame in a video stream to obtain a first vehicle license plate detection result, where the first vehicle license plate detection result is used to indicate whether a first vehicle license plate is included in the Nth image frame, and indicate a position of the first vehicle license plate in the Nth image frame if the first vehicle license plate detection result indicates that the first vehicle license plate is included in the Nth image frame, wherein N is an integer being greater than or equal to 1;

segment a character region and a number region from the first vehicle license plate according to the position of the first vehicle license plate in the Nth image frame and content information of the first vehicle license plate, if the first vehicle license plate detection result indicates that the first vehicle license plate is included in the Nth image frame; and

recognize the character region and the number region segmented from the first vehicle license plate to obtain a first recognition result of the first vehicle license plate.

In one preferable embodiment, the processor 50 is further configured to:

perform vehicle license plate detection on M image frames in the video stream to obtain M second vehicle license plate detection results, wherein the M second vehicle license plate detection results are used for indicating whether a second vehicle license plate is included in an image frame of the M image frames for the vehicle license plate detection, and further indicating the position of the second vehicle license plate in the image frame of the M image frames for the vehicle license plate detection, if the M second vehicle license plate detection results indicate that the second vehicle license plate is included in the image frame of the M image frames for the vehicle license plate detection, wherein the M image frames are the image frames subsequent to the Nth image frame, and M is greater than or equal to 1;

segment a character region and a number region from the at least one second vehicle license plate according to the position of at least one second vehicle license plate in the image frame of the M image frames for the vehicle license plate detection, and content information of the at least one second vehicle license plate, if at least one target vehicle license plate detection result(s) is included in the M second vehicle license plate detection results; where the position of the at least one second vehicle license plate in the image frame of the M image frames is indicated by the at least one target vehicle license plate detection result(s), the at least one target vehicle license plate detection result(s) refer to vehicle license plate detection result(s) that indicates the position of the at least one second vehicle license plate in the image frame of the M image frames for the vehicle license plate detection;

recognize a character region and a number region segmented from the at least one second vehicle license plate to obtain at least one second recognition result of the at least one second vehicle license plate;

determine whether the at least one second vehicle license plate matches with the first vehicle license plate according to the position of the at least one second vehicle license plate in the image frame of the M image frames for the vehicle license plate detection, and the position of the first vehicle license plate in the Nth image frame; and

determine an output vehicle license plate recognition result according to the first recognition result of the first vehicle license plate and target recognition result(s), wherein the target recognition result(s) refers to second recognition result(s) of the second vehicle license plate that matches with the first vehicle license plate.

In one preferable embodiment, when a number of the target recognition results is greater than or equal to 2, the processor 50 is configured to determine the output vehicle license plate recognition result according to the first recognition result of the first vehicle license plate and the target recognition result(s) by performing the operations of:

splitting the first recognition result to obtain a first split content according to a preset output format, wherein the first split content comprises at least two split sub-contents, and each split sub-content corresponds to one confidence;

splitting the at least two target recognition results to obtain at least two second split contents according to the preset output format, where each of the two second split contents comprises at least two split sub-contents, and each split sub-content corresponds to one confidence; and

accumulating values of confidences corresponding to a same split sub-content in the first split content and the at least two second split contents, and selecting the split sub-content having higher accumulated values of confidences to make up the output vehicle license plate recognition result according to the preset output format.

In one preferable embodiment, when there are more than one first vehicle license plates and there are more than one second vehicle license plates, the processor 50 is configured to determine whether the at least one second vehicle license plate matches with the first vehicle license plate according to the position of the at least one second vehicle license plate in the image frame of the M image frames for the vehicle license plate detection, and the position of the first vehicle license plate in the Nth image frame by performing the operations of:

selecting M image frame queues from image frames ranging from the Nth image frame to a (N+M)th image frame, where each of the M image frame queues includes two adjacent image frames;

performing an operation of determining whether the first vehicle license plate matches with the second vehicle license plate according to the position of the second vehicle license plate in each image frame of the M image frame queues and the position of the first vehicle license plate in each image frame of the M image frame queues, for each of the M image frame queues; and

repeatedly performing the operation on each of the M image frame queues until determination of matching of the first vehicle license plate and the second vehicle license plate in each of the M image frame queues is completed.

In one preferred embodiment, the processor 50 is configured to determine whether the first vehicle license plate matches with the second vehicle license plate according to the position of the second vehicle license plate in each image frame of the M image frame queues and the position of the first vehicle license plate in each image frame of the M image frame queues by performing the operations of:

determining an IoU of a detection frame Rᵢ and a detection frame Rⱼ to obtain IoU of elements in a sequence S₁ and elements in a sequence S₂; wherein the detection frame Rᵢ is any one of the elements in the sequence S₁ and the detection frame Rⱼ is any one of the elements in the sequence S₂, the sequence S₁ includes detection frames of the first vehicle license plate, the sequence S₂ includes detection frames of the second vehicle license plate, the position of the first vehicle license plate in the Nth image frame and the position of the second vehicle license plate in the (N+1)th image frame are represented by the detection frames corresponding to the first vehicle license plate and the second vehicle license plate respectively;

taking the IoU as a weight value of an edge that connects the detection frame R₁ with the detection frame R₂;

taking the detection frames in the sequence S₁ and the detection frames in the sequence S₂ as vertexes of a bipartite graph, and initializing weights of the vertexes of the bipartite graph; where a weight value of each vertex in the sequence S₁ is a maximum weight value of the edge connected with the detection frame that corresponds to the vertex in the sequence S1, a weight value of each vertex in the sequence S₂ is a first preset value less than 0.5; and

with regard to the vertex X in the sequence S₁, searching an edge that has a weight value being identical to the weight value of the vertex X in the sequence S₂, and determining that the first vehicle license plate corresponding to the vertex X in the sequence S₁ is successfully matched if the edge that has the weight value being identical to the weight value of the vertex X in the sequence S₂ is searched out; or determining that the first vehicle license plate corresponding to the vertex X in the sequence S₁ is not matched if the edge that has the weight value being identical to the weight value of the vertex X cannot be searched out in the sequence S₂; wherein the vertex X is any vertex in the sequence S₁.

In one preferable embodiment, the processor 50 is configured to determine that the first vehicle license plate corresponding to the vertex X in the sequence S₁ is not matched if the edge that has the weight value being identical to the weight value of the vertex X in the sequence S₂ cannot be searched out by performing the operations of:

subtracting the weight value of the vertex X by a second preset value, and increasing a weight value of the vertex corresponding to the detection frame connected with the detection frame that corresponds to the vertex X by the second preset value, where the second preset value is greater than 0;

taking a vertex subsequent to the vertex X as a new vertex X, and returning to perform the step of searching the edge that has the weight value being identical to the weight value of the vertex X in the sequence S₂ and determining that the first vehicle license plate corresponding to the vertex X in the sequence S₁ is successfully matched if the edge that has the weight value being identical to the weight value of the vertex X in the sequence S₂ is searched out; or determining that the first vehicle license plate corresponding to the vertex X in the sequence S₁ is not matched if the edge that has the weight value being identical to the weight value of the vertex X cannot be searched out in the sequence S₂, and determining that the first vehicle license plate corresponding to the vertex X in the sequence S₁ is not matched when the weight value of the edge being identical to the weight value of the vertex X is searched out again in the sequence S₂, and the weight value of the vertex X becomes 0.

In one preferable embodiment, the processor 50 is configured to recognize the character region and the number region segmented from the first vehicle license plate to obtain the first recognition result of the first vehicle license plate by performing the operations of:

combining the character region and the number region segmented from the first vehicle license plate into first information to be recognized in a fixed format, and recognizing the first information to be recognized to obtain the first recognition result of the first vehicle license plate.

In one preferable embodiment, the processor 50 is configured to segment the character region and the number region from the first vehicle license plate according to the position of the first vehicle license plate in the Nth image frame and the content information of the first vehicle license plate by performing the operations of:

determining a format of the first vehicle license plate according to the content information of the first vehicle license plate, wherein the format of the first vehicle license plate is used for indicating positions where the character region and the number region of the first vehicle license plate are positioned in the first vehicle license plate, respectively; and

segmenting the character region and the number region from the first vehicle license plate according to the position of the first vehicle license plate in the Nth image frame and the format of the first vehicle license plate.

In one preferable embodiment, the processor 50 is configured to segment the character region and the number region from the first vehicle license plate according to the position of the first vehicle license plate in the Nth image frame and the content information of the first vehicle license plate by performing the operations of:

extracting, according to the position of the first vehicle license plate, the region of the first vehicle license plate from the Nth image frame in the Nth image frame to obtain the first vehicle license plate image;

performing at least one processing on the first vehicle license plate image, the at least one processing includes: correction processing, image enhancement processing, de-noising processing, nose abatement processing, defuzzification processing and normalization processing, wherein the correction processing is used for correcting the first vehicle license plate image with angular deflection into a first flatten vehicle license plate image, the normalization processing is used for realizing standardized distribution of range domains of pixels of the first vehicle license plate image by normalization processing; and

segmenting the character region and the number region from the first processed vehicle license plate image.

In one preferable embodiment, the processor 50 is configured to segment the character region and the number region from the first processed vehicle license plate image by performing the operations of:

segmenting the character region of pixel level and the number region of pixel level from the first processed vehicle license plate image using a semantic segmentation model.

The electronic device 5 can be a computing device such as a desktop computer, a laptop computer, a palm computer, a cloud server, etc. The electronic device 5 can include but is not limited to: the processor 50 and the memory 51. The person of ordinary skill in the art will be appreciated that, FIG. 4 only illustrates an example of the electronic device 5, but should not be constituted as limitation to the electronic device 5, more or less components than the components shown in FIG. 4 can be included, as an alternative, some components or different components can be combined; for example, the electronic device 5 can also include an input and output device, a network access device, etc.

The so called processor 50 can be CPU (Central Processing Unit), and can also be other general purpose processor, DSP (Digital Signal Processor), ASIC (Application Specific Integrated Circuit), FGPA (Field-Programmable Gate Array), or some other programmable logic devices, discrete gate or transistor logic device, discrete hardware component, etc. The general purpose processor can be a microprocessor, as an alternative, the processor can also be any conventional processor, and the like.

In some embodiments, the memory 51 can be an internal storage unit of the electronic device 5, such as a hard disk or a memory of the electronic device 5. The memory 51 can also be an external storage device of the electronic device 5, such as a plug-in hard disk, a SMC (Smart Media Card), a SD (Secure Digital) card, a FC (Flash Card) equipped on the electronic device 5. Furthermore, the memory 51 can not only include the internal storage unit of the electronic device 5 but also include the external memory of the electronic device 5. The memory 51 is used to store an operating system, application programs, BootLoader, data and other procedures such as program codes of the computer program. The memory 51 can also be used to store data that has been output or being ready to be output temporarily.

An electronic device is further provided in one embodiment of the present disclosure, the network device includes at least one processor, a memory, and a computer program stored in the memory and executable on the at least one processor, when the computer program is executed by the processor, the processor is configured to implement the steps in any one of the various method embodiments.

A computer readable storage medium is further provided in on embodiment of the present disclosure, where the computer readable storage medium stores a computer program that, when executed by a processor, causes the processor to implement the steps in the various method embodiments.

A computer program product is also provided in one embodiment of the present disclosure, when the computer program product is executed by a mobile terminal, the mobile terminal is caused to perform the steps in the various method embodiments.

A whole or part of flow process for implementing the method in the embodiments of the present disclosure can also be accomplished in the manner of using computer program to instruct relevant hardware. When the computer program is executed by the processor, the steps in the various method embodiments described above may be implemented. Wherein, the computer program comprises computer program codes, which may be in the form of source code, object code, executable documents or some intermediate form, etc. The computer readable storage medium can at least include: recording medium, computer memory, ROM (Read-Only Memory), RAM (Random Access Memory), and software distribution medium, such as USB flash disk, mobile hard disk, hard disk, optical disk, etc.

It is obvious to the person of ordinary skill in the art that, the elements and algorithm steps of each of the examples described in connection with the embodiments disclosed herein may be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present disclosure.

As stated above, the foregoing are only intended to explain rather than limit the technical solutions of the present disclosure. Although the present disclosure has been explained in detail with reference to the embodiments, the person of ordinary skilled in the art will be appreciated that, the technical solutions disclosed in the embodiments can also be amended, as an alternative, some technical features in the technical solutions may be equivalently replaced; the amendments or the equivalent replacements don't cause the essence of corresponding technical solution to be broken away from the spirit and the scopes of the technical solutions in the various embodiments of the present disclosure, and thus should all be included in the protection scope of the present disclosure.

What is claimed is:

1. A vehicle license plate recognition method implemented by an electronic device comprising a memory and at least one processor, the method comprising steps of:
by the at least one processor, performing a vehicle license plate detection on a Nth image frame in a video stream to obtain a first vehicle license plate detection result, wherein the first vehicle license plate detection result is used to indicate whether a first vehicle license plate is included in the Nth image frame, and indicate a position of the first vehicle license plate in the Nth image frame if the first vehicle license plate detection result indicates that the first vehicle license plate is included in the Nth image frame, wherein N is an integer greater than or equal to 1;
by the at least one processor, segmenting a character region and a number region from the first vehicle license plate according to the position of the first vehicle license plate in the Nth image frame and content information of the first vehicle license plate, if the first vehicle license plate detection result indicates that the first vehicle license plate is included in the Nth image frame; and
by the at least one processor, recognizing the character region and the number region segmented from the first vehicle license plate to obtain a first recognition result of the first vehicle license plate.

2. The vehicle license plate recognition method according to claim 1, further comprising steps of:
performing vehicle license plate detection on M image frames in the video stream to obtain M second vehicle license plate detection results, wherein the M second vehicle license plate detection results are used for indicating whether a second vehicle license plate is included in an image frame of the M image frames for the vehicle license plate detection, and further indicating the position of the second vehicle license plate in the image frame of the M image frames for the vehicle license plate detection, if the M second vehicle license plate detection results indicate that the second vehicle license plate is included in the image frame of the M image frames for the vehicle license plate detection, wherein the M image frames are the image frames subsequent to the Nth image frame, and M is greater than or equal to 1;
segmenting a character region and a number region from the at least one second vehicle license plate according to the position of at least one second vehicle license plate in the image frame of the M image frames for the vehicle license plate detection, and content information of the at least one second vehicle license plate, if at least one target vehicle license plate detection result(s) is included in the M second vehicle license plate detection results; wherein the position of the at least one second vehicle license plate in the image frame of the M image frames is indicated by the at least one target vehicle license plate detection result(s), the at least one target vehicle license plate detection result(s) refer to vehicle license plate detection result(s) that indicates the position of the at least one second vehicle license plate in the image frame of the M image frames for the vehicle license plate detection;
recognizing a character region and a number region segmented from the at least one second vehicle license plate to obtain at least one second recognition result of the at least one second vehicle license plate;
determining whether the at least one second vehicle license plate matches with the first vehicle license plate according to the position of the at least one second vehicle license plate in the image frame of the M image frames for the vehicle license plate detection, and the position of the first vehicle license plate in the Nth image frame; and
determining an output vehicle license plate recognition result according to the first recognition result of the first vehicle license plate and target recognition result(s), wherein the target recognition result(s) refers to second recognition result(s) of the second vehicle license plate that matches with the first vehicle license plate.

3. The vehicle license plate recognition method according to claim 2, wherein when a number of the target recognition results is greater than or equal to 2, the step of determining the output vehicle license plate recognition result according to the first recognition result of the first vehicle license plate and the target recognition result(s) comprises:
splitting the first recognition result to obtain a first split content according to a preset output format, wherein the first split content comprises at least two split sub-contents, and each split sub-content corresponds to one confidence;
splitting the at least two target recognition results to obtain at least two second split contents according to the preset output format, wherein each of the two second split contents comprises at least two split sub-contents, and each split sub-content corresponds to one confidence; and
accumulating values of confidences corresponding to a same split sub-content in the first split content and the at least two second split contents, and selecting the split sub-content having higher accumulated values of confidences to make up the output vehicle license plate recognition result according to the preset output format.

4. The vehicle license plate recognition method according to claim 2, wherein when there are more than one first vehicle license plates and there are more than one second vehicle license plates, the step of determining whether the at least one second vehicle license plate matches with the first vehicle license plate according to the position of the at least one second vehicle license plate in the image frame of the M image frames for the vehicle license plate detection, and the position of the first vehicle license plate in the Nth image frame comprises:
selecting M image frame queues from image frames ranging from the Nth image frame to a (N+M)th image frame, wherein each of the M image frame queues comprises two adjacent image frames;
performing an operation of determining whether the first vehicle license plate matches with the second vehicle license plate according to the position of the second vehicle license plate in each image frame of the M image frame queues and the position of the first vehicle license plate in each image frame of the M image frame queues, for each of the M image frame queues; and
repeatedly performing the operation on each of the M image frame queues until determination of matching of the first vehicle license plate and the second vehicle license plate in each of the M image frame queues is completed.

5. The vehicle license plate recognition method according to claim 4, wherein the step of determining whether the first vehicle license plate matches with the second vehicle license plate according to the position of the second vehicle license plate in each image frame of the M image frame queues and the position of the first vehicle license plate in each image frame of the M image frame queues comprises:
determining an IoU of a detection frame Rᵢ and a detection frame Rⱼ to obtain IoU of elements in a sequence S₁ and elements in a sequence S₂; wherein the detection frame Rᵢ is any one of the elements in the sequence S₁ and the detection frame Rⱼ is any one of the elements in the sequence S₂, the sequence S₁ comprises detection frames of the first vehicle license plate, the sequence S₂ comprises detection frames of the second vehicle license plate, the position of the first vehicle license plate in the Nth image frame and the position of the second vehicle license plate in the (N+1)th image frame are represented by the detection frames corresponding to the first vehicle license plate and the second vehicle license plate respectively;
taking the IoU as a weight value of an edge that connects the detection frame R₁ with the detection frame R₂;
taking the detection frames in the sequence S₁ and the detection frames in the sequence S₂ as vertexes of a bipartite graph, and initializing weights of the vertexes of the bipartite graph; wherein a weight value of each vertex in the sequence S₁ is a maximum weight value of the edge connected with the detection frame that corresponds to the vertex in the sequence S1, a weight value of each vertex in the sequence S₂ is a first preset value less than 0.5; and
with regard to the vertex X in the sequence S₁, searching an edge that has a weight value being identical to the weight value of the vertex X in the sequence S₂, and determining that the first vehicle license plate corresponding to the vertex X in the sequence S₁ is successfully matched if the edge that has the weight value being identical to the weight value of the vertex X is searched out in the sequence S₂; or determining that the first vehicle license plate corresponding to the vertex X in the sequence S₁ is not matched if the edge that has a weight value being identical to the weight value of the vertex cannot be searched out in the sequence S₂, wherein X is any vertex in the sequence S₁.

6. The vehicle license plate recognition method according to claim 5, wherein the step of determining that the first vehicle license plate corresponding to the vertex X in the sequence S₁ is not matched if the edge that has the weight value being identical to the weight value of the vertex X in the sequence S₂ cannot be searched out comprises:
subtracting the weight value of the vertex X by a second preset value, and increasing a weight value of the vertex corresponding to the detection frame connected with the detection frame that corresponds to the vertex X by the second preset value, wherein the second preset value is greater than 0;
taking a vertex subsequent to the vertex X as a new vertex X, and returning to the step of searching the edge that has the weight value being identical to the weight value of the vertex X in the sequence S₂, and determining that the first vehicle license plate corresponding to the vertex X in the sequence S₁ is successfully matched if the edge that has the weight value being identical to the weight value of the vertex X is searched out in the sequence S₂; or determining that the first vehicle license plate corresponding to the vertex X in the sequence S₁ is not matched if the edge that has a weight value being identical to the weight value of the vertex cannot be searched out in the sequence S₂, and determining that the first vehicle license plate corresponding to the vertex X in the sequence S₁ is not matched when the weight value of the edge being identical to the weight value of the vertex X is searched out again in the sequence S₂, and the weight value of the vertex X becomes 0.

7. The vehicle license plate recognition method according to claim 1, wherein the step of recognizing the character region and the number region segmented from the first vehicle license plate to obtain the first recognition result of the first vehicle license plate comprises:
combining the character region and the number region segmented from the first vehicle license plate into first information to be recognized in a fixed format, and recognizing the first information to be recognized to obtain the first recognition result of the first vehicle license plate.

8. The vehicle license plate recognition method according to claim 1, wherein the step of segmenting the character region and the number region from the first vehicle license plate according to the position of the first vehicle license plate in the Nth image frame and the content information of the first vehicle license plate comprises:
determining a format of the first vehicle license plate according to the content information of the first vehicle license plate, wherein the format of the first vehicle license plate is used for indicating positions where the character region and the number region of the first vehicle license plate are positioned in the first vehicle license plate, respectively; and
segmenting the character region and the number region from the first vehicle license plate according to the position of the first vehicle license plate in the Nth image frame and the format of the first vehicle license plate.

9. The vehicle license plate recognition method according to claim 1, wherein the step of segmenting the character region and the number region from the first vehicle license plate according to the position of the first vehicle license plate in the Nth image frame and the content information of the first vehicle license plate comprises:
extracting, according to the position of the first vehicle license plate, the region of the first vehicle license plate from the Nth image frame in the Nth image frame to obtain the first vehicle license plate image;
performing at least one processing on the first vehicle license plate image, wherein the at least one processing comprises: correction processing, image enhancement processing, de-noising processing, nose abatement processing, defuzzification processing and normalization processing, the correction processing is used for correcting the first vehicle license plate image with angular deflection into a first flatten vehicle license plate image, and the normalization processing is used for realizing standardized distribution of range domains of pixels of the first vehicle license plate image by normalization processing; and
segmenting the character region and the number region from the first processed vehicle license plate image.

10. The vehicle license plate recognition method according to claim 9, wherein the step of segmenting the character region and the number region from the first processed vehicle license plate image comprises:
segmenting the character region of pixel level and the number region of pixel level from the first processed vehicle license plate image using a semantic segmentation model.

11. An electronic device, comprising a memory, at least one processor, and a computer program stored in the memory and executable by the processor, wherein when the computer program is executed by the at least one processor, the at least one processor is configured to:
perform a vehicle license plate detection on a Nth image frame in a video stream to obtain a first vehicle license plate detection result, wherein the first vehicle license plate detection result is used to indicate whether a first vehicle license plate is included in the Nth image frame, and indicate a position of the first vehicle license plate in the Nth image frame if the first vehicle license plate detection result indicates that the first vehicle license plate is included in the Nth image frame, wherein N is an integer greater than or equal to 1;
segment a character region and a number region from the first vehicle license plate according to the position of the first vehicle license plate in the Nth image frame and content information of the first vehicle license plate, if the first vehicle license plate detection result indicates that the first vehicle license plate is included in the Nth image frame; and
recognize the character region and the number region segmented from the first vehicle license plate to obtain a first recognition result of the first vehicle license plate.

12. A non-transitory computer readable storage medium which stores a computer program that, when executed by a processor, causes the processor to implement operations for vehicle license plate recognition, comprising:
performing a vehicle license plate detection on a Nth image frame in a video stream to obtain a first vehicle license plate detection result, wherein the first vehicle license plate detection result is used to indicate whether a first vehicle license plate is included in the Nth image frame, and indicate a position of the first vehicle license plate in the Nth image frame if the first vehicle license plate detection result indicates that the first vehicle license plate is included in the Nth image frame, wherein N is an integer being greater than or equal to 1;
segmenting a character region and a number region from the first vehicle license plate according to the position of the first vehicle license plate in the Nth image frame and content information of the first vehicle license plate, if the first vehicle license plate detection result indicates that the first vehicle license plate is included in the Nth image frame; and
recognizing the character region and the number region segmented from the first vehicle license plate to obtain a first recognition result of the first vehicle license plate.
